(19) United States
(12) Patent Application Publication
(10) Pub. No.: US 2012/0004922 A1
(43) Pub. Date: Jan. 5, 2012

(54) SYSTEM AND METHODS FOR IMPROVING SEARCH ENGINE RESULTS BY CORRELATING RESULTS WITH FEE

(76) Inventor: Dante Monteverde, Barrington Hills, IL (US)

(21) Appl. No.: 12/827,738

(22) Filed: Jun. 30, 2010

(51) Int. Cl. G06F 17/30; G06Q 30/00

(52) U.S. Cl. 705/1.1; 707/728; 707/706; 707/E17.108

(57) ABSTRACT

Search engine methods and systems are disclosed wherein search results presented in response to a search request include, in a single series, search results known to be relevant to the search request and search results whose relevance to the search request are not known, the latter being included based on a submission to the search engine. In a preferred form, a fee or payment is provided to the search engine operators in exchange for including, for a trial basis, the submission in the search results. Beyond the trial, the submission must demonstrate search user approval to be maintained in the search results for the searched query.

### FIELD OF THE INVENTION

The invention relates to search engines and, in particular, to search engines that allow website operators to be listed in a normal for-fee commercial advertising manner.

### BACKGROUND

Currently, one of the highest-valued Internet or Web-based utilities is the basic search engine. Many of the largest Internet-only companies rely on search activity to generate their largest amount of traffic and, thus, revenues.

There are many methods for producing a set of search results from a query input to a search engine, typically via an interface of a web browser. For the sake of convenience, the individual entries in the set of results are referred to as links herein. Some of these methods are proprietary, some are secret, some are simple, and others are quite complex. However, there are two basic manners in which the links are collected, those being through the use of specialized applications that seek out webpages (known as crawlers or spiders) and through manual input or identification of the links which often occurs by a website seeking to be included in a search engine's results. In the latter of these cases, the website operators may pay a fee in order to be in a section of sponsored links, or to receive a preferred ranking within the search result list.

In response to a query, the search results are displayed on the browser of the user who input the query. While the algorithms for various search engines may vary, a common manner for selecting the search results from the databases of the engine is identifying the relevance of the search query to information contained in the webpage, such information previously having been collected. For instance, if a search query has a single word, the links produced by the engine would likely have a high usage of that word in the page to which the link directs.

Such engines are susceptible to manipulation by website operators. A website operator may generate revenue from advertising on the webpages of the website simply by virtue of hits or views of the webpage. Accordingly, an unscrupulous website operator may employ a variety of tactics to generate views of the webpage, regardless of whether the webpage is truly targeted by the user's search query.

As stated before, the engine collects information from the identified webpages. A portion of this information is legitimately related to the useful contents of the webpage, such that identification of website based on the search query is also useful to the searching user; however, some is not. The actual forms of worthless information, such as metatags or text that does not appear to a user (which can be done by reducing font size or by matching text color with background color, or by hiding the text behind a graphic), is not important. What is important is that such practices can result in a number of the links returned in response to a search query being based on this worthless information and, thus, the webpage is of little to no use to the searching user.

It should be noted that search companies target the consumer, the end search user. This, historically, has been achieved by the fastest search engines with the most appropriate results. Of course, many users do not compare search results from one engine with another, and they typically respond best to an interface that loads quickly and returns results quickly. To a degree, users also expect to receive highly appropriate results for a targeted search, meaning input query of “White House” should receive whitehouse.gov as the formal residence of the President of the United States as the first result link.

The goal of search engines has been to improve their accuracy for the results. For instance, Microsoft® advertises its website Bing.com® as having more accurate results than other search engines. Unfortunately, this accuracy is driven by complex algorithms that try to determine that to which a website or page is truly relevant.

Typically, a search returns two sets of results: a first set comprising algorithm-based results and a second set comprising sponsor links. Heretofore, the two sets of results have not been blended for fear of squeezing one or the other. Therefore, unscrupulous website operators are able to land their websites in search results to which they do not pertain by various artifices, which forces small operators to employ the same tactics or risk never being found. As an example, a small microbrewer would have a difficult time being ranked very highly. Of course, that microbrewer would also have a tough time paying to be ranked in the sponsor links because the cost to compete with the not-so-small microbrewers on a consistent basis would be prohibitive.

Accordingly, there has been a need for improved methods and systems with which to monetize search results for a search engine, to improve search results by allowing a fee-based ranking, and to improve results by combining fee-based rankings with traffic and algorithm based rankings.

### SUMMARY

In accordance with an aspect, a web-based computer system search engine for receiving search queries and returning search results is disclosed including an input for a search query, the input displayed on a webpage of a browser provided at a remote computer by a user, a processor for receiving the search query from the user computer, and a storage for storing correlated websites, links, and information relevant to the content of the websites, wherein the system produces a results webpage for display on the user computer in response to the search query, the results webpage including links listed according to a ranking of relevance to the search query, the storage including links submitted by website operators for listing in the results webpage regardless of a ranking of relevance to the search query, wherein the results webpage for at least one search query displays links ranked according to relevance to the search query and at least one link ranked according to the website operator submission.

In some forms, the website operator submission includes search terms of relevance for the link to be displayed as a search result.

In some forms, the website operator pays a fee for the link to be in included as a search result for one or more search query.

In some forms, the links are listed as a single series.

In some forms, the operator submission link is maintained in the search results for the search query for a predetermined time.

In some forms, the operator submission links are maintained in the search results for respective queries for respective predetermined periods, and continued maintenance in the search results is based on user usage of the links.

In some forms, the operator submission link is maintained in the search results for the search query for a predetermined number of hits.

In some forms, the operator submission links are maintained in the search results for respective queries for respective predetermined periods, and continued maintenance in the search results is based on user usage of the links.

In another aspect, a method of presenting web-based search results relative to a search query is disclosed including the steps of providing a search engine having a storage portion storing information relevant to identified websites, and including a processing portion, the stored information including links to websites ranked relative to search queries based on demonstrated relevance to the search queries and including links submitted without known relevance to the search queries, displaying a search engine interface webpage on a user computer, receiving a search query from the user via the interface webpage, processing, via the processing portion, the search query to determine a ranked set of results from the storage portion, and displaying at least a portion of the ranked set of results as a results webpage on the user computer, the at least a portion of the ranked set of results including at least one of the submitted link without known relevance to the search query.

In some forms, the method further includes the step of maintaining each submitted link in the search result for a predetermined period of time.

In some forms, the method further includes the step of maintaining each submitted link in the search result for a predetermined number of hits.

In some forms, the method further includes maintaining the submitted link in the search result based on user approval.

In some forms, the method further including removing the submitted link in the search result based on a lack of user approval.

### BRIEF DESCRIPTION OF THE DRAWINGS

FIG. 1 is a graphical illustration of a system of the present invention;

FIG. 2 is a PRIOR ART representational view of a computer monitor and web browser displaying a set of search results in the web browser, the search results including a first series and a second series of links, the search results being displayed in response to a particular search query; and

FIG. 3 is a representational view of the computer monitor and web browser of FIG. 2 displaying a set of search results in the web browser, the search results including a single series of links provided by the present invention.

### DETAILED DESCRIPTION

The present invention entails systems and methods whereby search results based on a search query to a web-search engine are improved by allowing fee-based ranking and by combining fee-based rankings with traffic and algorithm based rankings, and whereby ranking in a search result listing is monetized for the search engine.

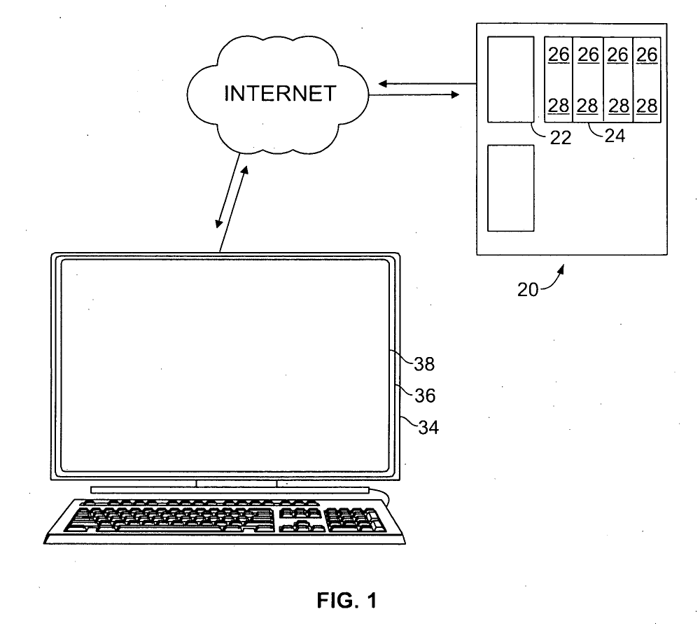

Referring to FIG. 1, a system of the present invention is illustrated including a search engine 20 having a processor module 22 and a storage module 24. Initially, the storage module 24 may be populated with webpages 26 and information 28 thereof in any manner, such as with the conventional use of spiders and crawlers and by direct input or submissions. In this manner, the engine 20 can be put online and provide reasonably sufficient search results. The present invention also contemplates being used or usable with existing search engines to modify how results and rankings are produced.

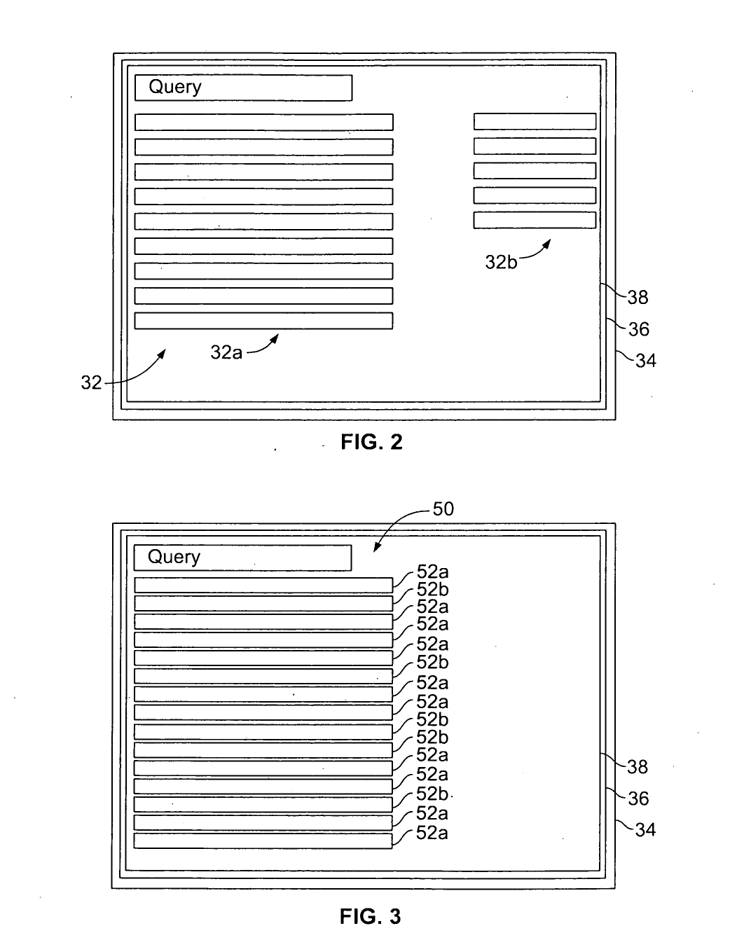

FIG. 2 illustrates results of a prior art search engine in which search results 32 are displayed on a monitor 34 of a computer. The computer is running, and the monitor 34 is displaying, a browser application 36 that itself is displaying the search results page 38 with the search results 32 thereon.

In FIG. 2, the search results 32 are in two categories. Links 32a are defined as search results that are populated by a ranking score based on relevance to the search query, as determined by description and text of the web page, as is known in the art. Links 32b are defined as search results that are populated on a fee or payment based and may be referred to as sponsor links 32b.

Consumers fear the ease with which the results 32 could be manipulated for profit by a search engine. Were a company to pay enough, and were a search engine complicit, the company could appear to be the premier provider of a particular good or service or, worse, the sole provider.

As the sponsor links 32b are relatively few on a page, there can be vigorous competition for these spots, and the search engine is able to monetize 20 these listings. Despite what some consumer advocates may say, such is no different than any other form of commercial and paid-for advertising.

Turning to FIG. 3, search results 50 of the present invention are illustrated. As can be seen, only a single set of links 52 are presented. In this manner, links 52a are displayed generally by a ranking that results from how accurately the link relates to the search query, and links 52b are displayed therealong (preferably without any indication of the difference between links 52a and 52b) that result from a paid-for-ranking listing. In the prior art, the sponsor links 32b are continually paid for, in the same way in which an advertiser continues to pay for radio play or for billboard space. In the present invention, the paid-for links 52b require a limited payment. Accordingly, the owners of the paid-for-ranking links 52b need not make the same type of capital commitment in order to get-in-the-game, as it were. In other words, the owner of a website can pay a fee (such as a one-time fee) in order to be listed in the first page of results for a particular search query. However, unlike the prior art sponsor links 32b where remaining highly ranked depends on continued fee payment, the paid-for-ranking links 52b have the opportunity to remain highly ranked simply by demonstrating that they belong in such a position. The balance includes links 52a that have already demonstrated their appropriateness as search results to the query.

In this manner, a website operator can make a reasoned economic decision on ranking. As discussed above, website operators often exploit the indexing of search engines by utilizing descriptions and titles that crawlers and spiders read such that the websites populate inappropriate search results, simply to generate traffic. In the present invention, website operators purchase the opportunity to appear in the rankings for a period of time, and then it is up to the websites themselves to remain in the rankings. If the website is inappropriate, it will fall out of the rankings, which will render the further payment to be in the rankings economically unsound. One may view an aspect of the method as paying for a trial basis.

This eventually shifts the burden of determining which websites are displayed for a search query from a computer (the processor portion 22 of the engine 20) to users and website operators. This removes, or greatly diminishes, the incentive of website operators to employ deceptive means to generate traffic. It also generates revenue for the search engine which, otherwise, is operating a free promotional service for the websites.

The paid-for-ranking links 52b do not remain indefinitely. A number of parameters can be used, either solely or jointly, for determining the period of ranking for the links 52b. As examples, the paid-for-ranking links 52b may be displayed for a particular number of hits, a particular period of time, or a particular number of searches. A pain-for-ranking link 52b may also fall more quickly if users repeatedly bypass the link 52b in favor of a link further down in the results set 50.

Beyond the initial period, the websites must be selected as permanent members so that the links 52b are selected as permanent members, essentially transforming the links 52b from paid-for-ranking links 52b to ordinarily-ranked links 52a.

The fee paid for the paid-for-ranking links 52b is preferably non-refundable and is for the link 52b to be returned for search terms of the selection by the owner of the link 52b website. The links 52b are rotated with the already approved and/or ordinarily-ranked links 52a so that all have an equal opportunity to be selected by users (which results in approval or rejection of the links 52b). However, it is preferred that the number of paid-for-ranking links 52b are limited relative to the other listings so as not to diminish the overall quality of the search results 52 in their totality. Click-throughs to websites via links 52a or 52b may generate a payment from the websites to the engine 20.

It should be noted that the present invention allows a search engine to operate efficiently in a market-based economy. Website operators essentially pay for the opportunity for their websites to be presented to users. The website operators make an economic choice on the value of that opportunity (as opposed to being able to achieve the same for free by manipulating how their sites appear to search engine spiders, for instance). After being presented to users, the websites have to demonstrate user approval and satisfaction, simply based on demand.

In some forms, the present invention is utilized in conjunction with dynamic ranking adjustment. Based on user usage of the search engine 20, the ranking for any particular link 42 may be adjusted upward, downward, or eliminated altogether. While the present invention allows a website to gain some recognition, get a foot in the door so to speak, the ability of the website to continue to receive a high ranking will be based on the website demonstrating it deserves to be in such position. Various forms of dynamic ranking adjustment are disclosed in co-pending and concurrently filed USSN ______ and USSN ______, the entirety of each being incorporated herein by reference.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A web-based computer system search engine for receiving search queries and returning search results, the system comprising:
an input for a search query, the input displayed on a webpage of a browser provided at a remote computer by a user;
a processor for receiving the search query from the user computer; and
a storage for storing correlated websites, links, and information relevant to the content of the websites;
wherein the system produces a results webpage for display on the user computer in response to the search query, the results webpage including links listed according to a ranking of relevance to the search query, the storage including links submitted by website operators for listing in the results webpage regardless of a ranking of relevance to the search query, wherein the results webpage for at least one search query displays links ranked according to relevance to the search query and at least one link ranked according to the website operator submission.

2. The system of claim 1 wherein the website operator submission includes search terms of relevance for the link to be displayed as a search result.

3. The system of claim 1 wherein the website operator pays a fee for the link to be in included as a search result for one or more search query.

4. The system of claim 1 wherein the links are listed as a single series.

5. The system of claim 1 wherein the operator submission link is maintained in the search results for the search query for a predetermined time.

6. The system of claim 5 wherein operator submission links are maintained in the search results for respective queries for respective predetermined periods, and continued maintenance in the search results is based on user usage of the links.

7. The system of claim 1 wherein the operator submission link is maintained in the search results for the search query for a predetermined number of hits.

8. The system of claim 7 wherein operator submission links are maintained in the search results for respective queries for respective predetermined periods, and continued maintenance in the search results is based on user usage of the links.

9. A method of presenting web-based search results relative to a search query, the method including the steps of:
providing a search engine having a storage portion storing information relevant to identified websites, and including a processing portion, the stored information including links to websites ranked relative to search queries based on demonstrated relevance to the search queries and including links submitted without known relevance to the search queries;
displaying a search engine interface webpage on a user computer;
receiving a search query from the user via the interface webpage;
processing, via the processing portion, the search query to determine a ranked set of results from the storage portion; and
displaying at least a portion of the ranked set of results as a results webpage on the user computer, the at least a portion of the ranked set of results including at least one of the submitted link without known relevance to the search query.

10. The method of claim 9 further including the step of maintaining each submitted link in the search result for a predetermined period of time.

11. The method of claim 9 further including the step of maintaining each submitted link in the search result for a predetermined number of hits.

12. The method of claim 9 further including maintaining the submitted link in the search result based on user approval.

13. The method of claim 9 further including removing the submitted link in the search result based on a lack of user approval.
